(19) United States
(12) Patent Application Publication
(10) Pub. No.: US 2026/0086009 A1
(43) Pub. Date: Mar. 26, 2026

(54) Testing device and testing method for mechanical properties of spray anchor net support system

(71) Applicant: Northeastern University, Shenyang (CN)

(72) Inventors: Xin WANG, Shenyang (CN); Xia-Ting FENG, Shenyang (CN); Zhiyuan ZHANG, Shenyang (CN); Kai ZHANG, Shenyang (CN); Shuai XU, Shenyang (CN); Ming CAI, Shenyang (CN); Pengyuan HOU, Shenyang (CN); Zaobao LIU, Shenyang (CN); Lin CHEN, Shenyang (CN); Kunmeng LI, Shenyang (CN); Boxue PANG, Shenyang (CN); Ziqiang ZENG, Shenyang (CN); Ankang XING, Shenyang (CN); Ruiqi GENG, Shenyang (CN); Yanling WANG, Shenyang (CN); Ben LI, Shenyang (CN); Hao JIANG, Shenyang (CN); Yi JIANG, Shenyang (CN); Jie XIE, Shenyang (CN); Jingwen LIU, Shenyang (CN); Zhuo CHEN, Shenyang (CN); Zhengming YANG, Shenyang (CN); Qiang WANG, Shenyang (CN); Jikai GAO, Shenyang (CN)

(73) Assignee: Northeastern University, Shenyang (CN)

(21) Appl. No.: 19/403,853

(22) Filed: Nov. 29, 2025

Related U.S. Application Data
(63) Continuation of application No. PCT/CN2024/093927, filed on May 17, 2024.

(30) Foreign Application Priority Data
May 31, 2023 (CN) 202310635123.1
Aug. 18, 2023 (CN) 202311046399.2

(51) Int. Cl. G01N 3/303; E21F 17/00

(52) U.S. Cl. CPC G01N 3/303; E21F 17/00; G01N 2203/0003; G01N 2203/001; G01N 2203/0033; G01N 2203/0048

(57) ABSTRACT

A testing device for mechanical properties of a spray anchor net support system, comprising a main frame (100), a lifting and transporting mechanism (200), a mechanical testing mechanism, a testing platform (500), and a monitoring mechanism (600). The lifting and transporting mechanism (200) is arranged on the main frame (100): the testing platform (500) comprises a mold set and a support assembly to be tested (530); the mold set is movably arranged on the main frame (100), and said support assembly (530) is arranged at the bottom end of the mold set, the mechanical testing mechanism is arranged corresponding to said support assembly (530) and is used for implementing a dynamic impact property test or a static mechanical property test on said support assembly (530); and the monitoring mechanism (600) is communicatively connected to the testing platform (500). The present invention further relates to a testing method for dynamic impact properties of a spray anchor net support system and a testing method for static mechanical properties of a spray anchor net support system.

### TECHNICAL FIELD

The invention relates to the technical field of underground rock engineering support system test equipment, especially to a testing apparatus and testing method for mechanical properties of a shotcrete-rock bolt-mesh support system.

### BACKGROUND

The geological conditions of deep underground engineering differ significantly from those of surface engineering. As underground engineering moves to deeper levels, the complex deep environment characterized by “three highs and one disturbance” (i.e., high stress, high temperature, high hydraulic pressure, and strong dynamic disturbance) also emerges. Underground excavation projects often encounter geological hazards such as large deformation and high-energy rockbursts. Therefore, to ensure the safety of underground engineering structures, a robust support system is crucial. In underground engineering, the support system often serves as the last line of defense against such disasters and plays a vital protective role.

Intense dynamic disturbances frequently act directly on the support system of underground structures, which can lead to deformation of the system, and may even cause support failure, resulting in major safety incidents. Such failures not only severely hinder normal production progress and compromise engineering quality but also pose serious threats to the safety of construction personnel and equipment. Hence, designing economical, effective, and rational support systems, and ensuring they fulfill their supporting function, represents a major challenge in deep underground engineering. A thorough understanding of the support properties of these systems is key to addressing this issue.

Moreover, shotcrete-rock bolt-mesh support is one of the most commonly used systems for reinforcing underground rock and soil. It typically consists of rock bolts, and surface support (i.e., mesh, shotcrete) installed within the rock mass. Effective support is essential in the design of underground rock excavations. The use of inappropriate support systems may lead to a range of problems and significantly impact the safety of workers and equipment. The effectiveness and properties of a shotcrete-rock bolt-mesh support system depend on the properties of the cable bolts and the surface support, the synergy between them, as well as the compatibility and interaction among all assembly of the support system. Therefore, an accurate understanding of the mechanical behavior and failure mechanisms of each components is also highly important for both surface support and overall support properties.

In China, research equipment related to the support properties of such systems has been developed in relevant fields, but the number of such devices is limited. Existing equipment tends to focus only on studying the mechanical properties of individual support elements, neglecting the overall support properties of the system. Even when overall properties are considered, the degree of realism in simulating actual engineering conditions is often low. For example: The invention CN112903482A by China Coal Mining Research Institute Co., Ltd. is a multi-functional test bench for impact load testing of mine support materials. It focuses on studying the mechanical properties of single support elements and can perform impact load tests on cable bolts (cables), steel meshes, steel strips, and anchored bodies. The invention CN110274831A by Shandong University of Science and Technology is a comprehensive testing apparatus for evaluating bolt (cable) support structures and the properties of anchorage systems. It can simulate combined support using bolts and steel mesh and test the properties of the anchorage system. The invention CN114383947A by China University of Mining and Technology (Beijing) is a dynamic-static coupling properties test system for multi-functional anchorage systems, capable of testing the mechanical properties of anchorage systems under coupled dynamic and static loading conditions. The invention CN107941620A by Shandong Jianzhu University is a mechanical properties testing and evaluation device and method for shotcrete-rock bolt-mesh support structures in underground engineering. It can load and unload different types of support structures, such as single rock bolts, steel mesh, or shotcrete, as well as combinations like bolt+steel mesh, bolt+shotcrete, steel mesh+shotcrete, or bolt+steel mesh+shotcrete. However, it has not achieved a high-fidelity overall properties test function that closely replicates real shotcrete-rock bolt-mesh support systems.

Therefore, to better study the support properties of underground engineering support systems, there is an urgent need to design a support system construction and shotcrete-rock bolt-mesh support properties testing apparatus that highly replicates the in-situ support configurations. This will provide reliable test equipment and data for support design under engineering conditions such as extremely high in-situ stress in deep engineering, and offer strong support for the design of support systems under intense dynamic disturbances.

### SUMMARY

### (1) Technical Problems to be Solved

In view of the above shortcomings and deficiencies of the existing technology, the invention provides a testing apparatus and testing method for mechanical properties of a shotcrete-rock bolt-mesh support system, thereby addressing the technical problem inherent in existing testing apparatus for mechanical properties of a shotcrete-rock bolt-mesh support system, which are limited to single-function designs and incapable of accurately restoring the anchor rod layout under actual engineering support conditions.

### (2) Technical Scheme

In order to achieve the above purpose, the invention provides a testing apparatus for mechanical properties of a shotcrete-rock bolt-mesh support system. The device includes: a main frame, a lifting and transporting mechanism, a mechanical testing mechanism, a testing platform and a monitoring mechanism; the lifting and transporting mechanism is disposed on the main frame; the testing platform includes a mold group and a support system; the mold group is movably disposed on the main frame, and the support system is disposed on a bottom of the mold group, the mechanical testing mechanism corresponds to a setting of the support system, configured to perform a dynamic impact testing or a static loading testing on the support system; the monitoring mechanism communicates with the testing platform.

In some embodiments, the main frame includes a pedestal, a frame column, a frame beam, a platform column and multiple sets of load transfer slide rails; the frame column and the platform column are disposed on the pedestal, the frame beam is connected to the frame column, and the lifting and transporting mechanism is disposed on the frame beam, the load transfer slide rail is connected to the platform column; the mold group is slidably disposed on the load transfer slide rail.

In some embodiments, the load transfer slide rail includes a first load transfer slide rail and a second load transfer slide rail; the first load transfer slide rail and the second load transfer slide rail both include two parallel sub-load transfer slide rails, two sub-load transfer slide rails of the second load transfer slide rail are located on both sides of the first load transfer slide rail, the mold group includes an inner mold, an outer mold and an test rock bolt; the inner mold is disposed on the first load transfer slide rail, and the outer mold is disposed between the first load transfer slide rail and the second load transfer slide rail, the test rock bolt is disposed in the inner mold and the outer mold in a detachable manner.

In some embodiments, the inner mold includes an inner mold shell and a support beam; the inner mold shell is connected to the first load transfer slide rail through the support beam; the outer mold includes an outer mold shell and an outer mold clamp plate; the outer mold is disposed between the first load transfer slide rail and the second load transfer slide rail through the outer mold clamp plate.

In some embodiments, the inner mold shell and the outer mold shell are provided with hole tubes.

In some embodiments, the mechanical testing mechanism is a dynamic impact testing mechanism, the dynamic impact testing mechanism includes an impact weight, a crane and a guide frame; the crane is connected to the lifting and transporting mechanism; the impact weight is connected to the crane in a detachable manner; the impact weight is disposed on the guide frame and may move along the guide frame, a bottom of the guide frame is aligned with the support system. In some embodiments, the guide frame is connected to the frame beam. The impact weight includes a weight frame, a weight, a locking wheel and a protective cylinder; the locking wheel is connected to the weight frame, the weight is disposed on the weight frame, and a bottom surface of the locking wheel is connected to the weight, and the protective cylinder is connected to the weight frame and disposed on a periphery of the weight.

In some embodiments, the mechanical testing mechanism is a test loading mechanism, the test loading mechanism includes a servo hydraulic jack and a longitudinal slide rail; the longitudinal slide rail is mounted on the frame column, and the Longitudinal slide rail is equipped with a longitudinal moving support; the servo hydraulic jack is disposed on the longitudinal moving support in a detachable manner through a bearing beam; a bottom of the servo hydraulic jack corresponds to the support system, configured to apply load to the support system; anchoring piers are disposed at a bottom of the support system, and the anchoring piers are disposed on a pier-anchor slideway.

In the second aspect, the invention provides a testing method for dynamic impact properties of the shotcrete-rock bolt-mesh support system. This method is based on the above-mentioned testing apparatus for the mechanical properties of the shotcrete-rock bolt-mesh support system. The testing method includes the following steps: constructing the testing platform, setting the mold group according to test requirements, and pouring concrete into the mold group; after concrete curing, installing test rock bolt in the mold group; when the test rock bolt is mounted in the mold group, installing the mold group on the load transfer slide rail, so that the test rock bolt is connected to other support components to be tested; determining an impact area of the dynamic impact test according to a position of the testing platform via the dynamic impact testing mechanism, the guide frame corresponds to the impact area, the guide frame is connected to the frame beam, and the crane is connected to the lifting and transporting mechanism, according to test requirements, setting the impact weight of the corresponding mass and connecting it to the crane. In the dynamic impact test, lifting the impact weight by the lifting and transporting mechanism to a position of the guide frame, the impact weight is aligned with a central axis of the guide frame, the crane releases the impact weight, potential energy generated by a free fall of the impact weight acts on the support system on the testing platform, recording test data by the monitoring mechanism and completing the impact test.

In the third aspect, the invention also provides another testing method for static mechanical properties of the shotcrete-rock bolt-mesh support system. This method is based on the above-mentioned testing apparatus for the mechanical properties of the shotcrete-rock bolt-mesh support system. The testing method includes the following steps: constructing the testing platform, setting the mold group according to the test requirements, and pouring the concrete into the mold group; after concrete curing, test rock bolt is mounted in the mold group; when the test rock bolt is mounted in the mold group, installing the mold group on the load transfer slide rail, so that the test rock bolt is connected to the support system; meanwhile, the support system is connected to the anchoring pier; according to a position of the testing platform, determining the impact area of the dynamic impact test, and then installing the bearing beam with servo hydraulic jack on the longitudinal moving support; and aligning a bottom of the servo hydraulic jack to the support system. Static loading test, pressing the bottom of the servo hydraulic jack against the support system, recording the test data by the monitoring mechanism, and completing the static mechanical properties test.

### (3) Beneficial Effects

The beneficial effect of the invention is that it provides a testing apparatus for the mechanical properties of the shotcrete-rock bolt-mesh support system. The mold group in the testing platform of the device can simulate the surrounding rock and the anchoring effect. Moreover, the mold group can be moved within the main frame, enabling it not only to simulate the setting of multiple anchors to achieve multi-point anchorage of the mesh as in actual engineering, but also to flexibly adjust the spacing and layout positions between the various molds in the mold group, thereby accommodating steel meshes of different sizes and facilitating multi-type and multi-specification testing. In addition, the movable mold group can also simulate the arrangement of anchor bolts in actual projects through positional adjustment, such as diamond pattern and square pattern of anchor bolt mounting, thus simulating and restoring various arrangement forms of anchor bolts under actual engineering support conditions. The mechanical testing mechanism in the invention can perform dynamic impact properties tests or static mechanical properties tests on the support system. The mechanical testing mechanism includes a dynamic impact testing mechanism and a test loading mechanism, both of which can be selected as needed. Among them, the dynamic impact testing mechanism provides the impact force required for the dynamic impact test, enabling the simulation of the interaction between rockburst, multi-level rockburst, “chain” rockburst, and the support system under conditions of deep extremely high ground stress. By flexibly changing the type of bolt or steel mesh, it is convenient to carry out various tests. By measuring the displacement and deformation of the support system, the deformation and energy absorption properties of different bolts, steel meshes, and shotcrete-bolt-mesh support assemblies under dynamic impact force may be tested. Through the analysis of the test results, the impact resistance of different anchors, steel meshes, and shotcrete-bolt-mesh support assemblies may be quantitatively evaluated, thereby providing technical support for the selection of support anchors, steel meshes, and shotcrete-bolt-mesh combined support systems used in underground engineering.

The adjustable positioning of the test loading mechanism diversifies the test forms of the invention. That is, it can not only configure multiple testing pattern to evaluate the overall energy absorption of the “shotcrete-bolt-mesh system, but also provide criteria for evaluating for the function, energy absorption properties, and failure mechanism of a variety of different support components in the entire supporting system, overcoming the technical limitations of the lack of test equipment and the previous reliance on engineering experience in support evaluation. In addition, during the test loading test of the shotcrete-rock bolt-mesh support system, the rock bolts consistent with those used in field applications are installed in the concrete. This improves upon previous testing apparatus, which failed to reproduce the actual stress conditions of the bolt in the rock mass, and more accurately restores real working conditions.

In summary, the invention can not only provide dynamic impact tests and other test conditions for the shotcrete-rock bolt-mesh support system through the dynamic impact testing mechanism, but also allow the optional use of the test loading mechanism to perform static loading tests of the shotcrete-rock bolt-mesh support system. Two share the main frame, lifting and hoisting device, testing platform, and monitoring system, which effectively solves the technical problems existing in the prior art and is conducive to popularization and application.

### BRIEF DESCRIPTION OF THE DRAWINGS

FIG. 1 is a schematic diagram of the overall structure of a state of the mechanical properties testing apparatus for the shotcrete-anchor-mesh support system of the invention (the right-side fence is hidden in the diagram);

FIG. 2 is a front view of FIG. 1.

FIG. 3 is a right view of FIG. 2 (the right enclosure is hidden in the figure).

FIG. 4 is a top view of FIG. 1.

FIG. 5 is a schematic diagram of the main frame structure.

FIG. 6 is a structural diagram of the lifting and transporting mechanism.

FIG. 7 is a structural diagram of the dynamic impact testing mechanism.

FIG. 8 is a structural diagram of the impact weight.

FIG. 9 is a structural diagram of the testing platform;

FIG. 10 is a structural diagram of the inner mold.

FIG. 11 is a structural diagram of the outer mold.

FIG. 12 is a structural diagram of pouring accessory (Outer mold).

FIG. 13 is a schematic diagram of the monitoring mechanism when using the dynamic impact testing mechanism.

FIG. 14 is a three-dimensional schematic diagram of the combination of the load transfer slide rail and the column rail support.

FIG. 15 is another structural diagram of pouring accessory (inner mold).

FIG. 16 shows the local magnification of the lifting structure.

FIG. 17 is an overall three-dimensional structural diagram of the other state of the mechanical properties testing apparatus of the shotcrete-rock bolt-mesh support system (for the test loading mechanism).

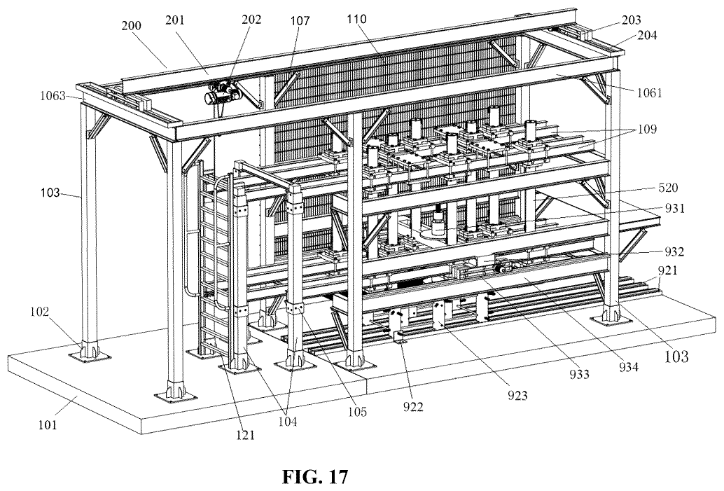

FIG. 18 is a top-down view of the structure shown in FIG. 17.

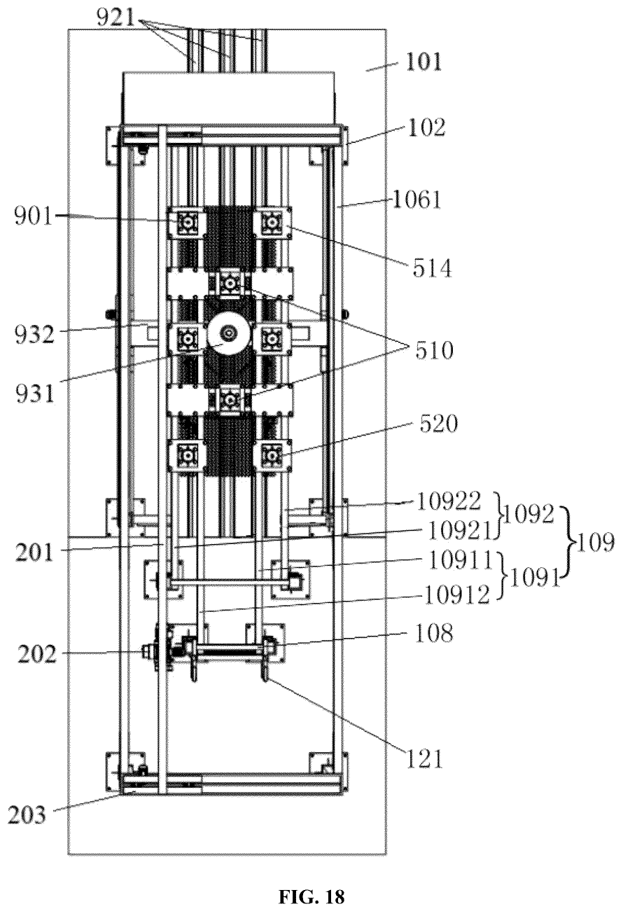

FIG. 19 is a side view diagram of the structure shown in FIG. 17.

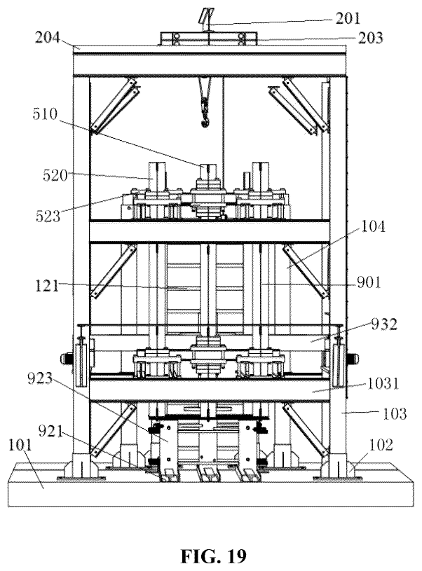

FIG. 20 is a structural diagram of the test loading mechanism for the structure shown in FIG. 17.

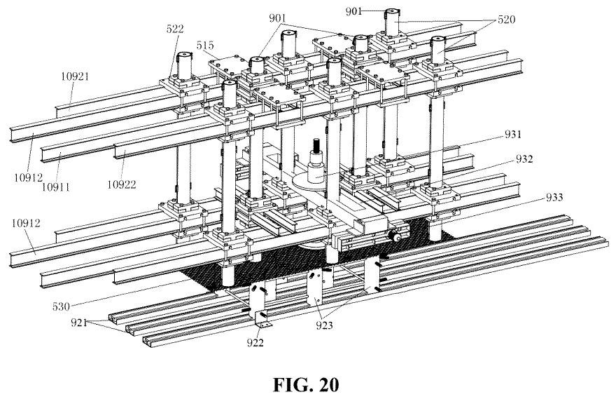

FIG. 21 is a structural diagram of the pier anchor assembly and the loading assembly for the structure shown in FIG. 17.

FIG. 22 is a structural diagram of another state of the mechanical properties testing apparatus of the shotcrete-rock bolt-mesh support system.

FIG. 23 is a structural diagram of the main assembly in FIG. 22.

FIG. 24 is a structural diagram of the lifting and transporting mechanism in FIG. 22.

FIG. 25 is a schematic diagram showing the mounting form of the inner mold and the outer mold in FIG. 22.

FIG. 26 is a schematic diagram showing the mounting method of the servo hydraulic jack in FIG. 22.

FIG. 27 is a schematic diagram showing the structure of the outer mold in FIG. 22.

FIG. 28 is a structural diagram of the servo hydraulic jack used in FIG. 26.

[Graphical Notes] 100: Main frame; 101: Pedestal; 102: Column base; 103: Frame column; 1031: Connecting beam; 104: Platform column; 1041: First platform column; 1042: Second platform column; 1043: Third platform column; 1044: Fourth platform column; 1046: Second auxiliary platform column; 1047: Third auxiliary platform column; 1048: Fourth auxiliary platform column; 105: Column rail brace; 1051: Extended plane; 10511: Bolt mounting hole; 106: Frame beam; 1061: First connecting beam; 1062: Second connecting beam; 1063: Third connecting beam; 1064: Fourth connecting beam; 107: Diagonal brace; 108: Cap beam; 109: Load transfer slide rail; 1091: First load transfer slide rail; 10911: First sub-load transfer slide rail; 10912: Second sub-load transfer slide rail; 1092: Second load transfer slide rail; 10921: Third sub-load transfer slide rail; 10922: Fourth sub-load transfer slide rail; 1093: Bolt hole; 1094: Mounting bolt; 110: Security fence network; 121: Escalator; 200: Lifting and transporting mechanism; 201: Hoisting beam; 202: Lifting part; 2021: Walking roller; 2022: Walking motor; 203: Paired sliding bearing; 204: Paired lateral slides; 205: Longitudinal moving vehicle; 206: Lateral moving vehicle; 300: Dynamic impact testing mechanism; 310: Impact weight; 311: Weight frame; 3111: Upper disc; 3112: Lower disc; 3113: Coupling; 312: Weight; 3121: Gap; 313: Locking wheel; 314: protective cylinder; 320: Crane; 320: Crane; 330: Guide frame; 3301: Hook; 500: Testing platform; 530: Support system; 510: Inner mold; 511: Half mold of inner mold; 512: Inner mold fastener; 5121: Upper inner mold clamping groove; 5122: Middle inner mold clamping groove; 5123: Lower inner mold clamping groove; 513: support beam; 514: Inner mold clamp plate; 5141: First clamp plate; 5142: Second clamp plate; 5143: inner clamp plate connecting bolt; 515: Track clamp plate; 5151: First rail clamp plate; 51511: Second positioning groove; 5152: Second track clamp plate; 51521: Third positioning groove; 516: Inner mold card; 520: Outer mold; 522: Outer mold fastener; 5221: Upper outer mold clamping groove; 5222: Middle outer mold clamping groove; 5223: Lower outer mold clamping groove; 5224: External fastener bolt; 523: Outer mold clamp plate; 5231: Third clamp plate; 5232: Fourth clamp plate; 5234: Outer plate connecting bolt; 5233: Fourth positioning groove; 530: Support system; 540: Pouring accessory; 543: Hole tube; 550: Clamping flange; 600: Monitoring institution; 610: Dynamic impact force monitor; 630: Displacement monitor; 640: Image collector; 650: Thermal energy monitor; 660: Data acquisition and display; 900: Test loading mechanism; 901: Bolt; 920: Connecting rod; 921: Pier anchor slide rail; 923: Anchoring pier; 9231: Mounting gap; 931: Servo hydraulic jack; 932: Bearing beam; 9321: Vertical reinforcement; 9322: Tendon hook; 933: Longitudinal moving bearing; 934: Longitudinal slide rail.

### DETAILED DESCRIPTION OF THE EMBODIMENTS

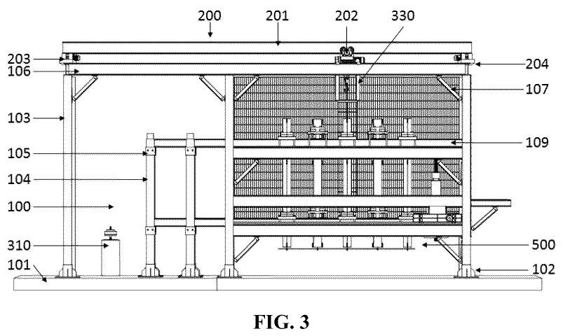

In order to better explain the invention, in order to facilitate understanding, the following combined with the attached diagram, through the specific embodiment, the invention is described in detail. Among them, the orientation nouns such as “upper” and “lower” mentioned in this disclosure are based on the orientation of FIG. 3.

A testing apparatus and testing method for mechanical properties of shotcrete-rock bolt-mesh support system are proposed in the embodiment of the invention, including a main frame 100, a lifting and transporting mechanism 200, a mechanical testing mechanism, a testing platform 500 and a monitoring mechanism 600. The lifting and transporting mechanism 200 is disposed on the main frame 100, the testing platform 500 includes a mold group and a support system 530. The mold group is movablely disposed on the main frame 100, and the support system 530 is disposed at the bottom of the mold group. The mechanical testing mechanism is set up corresponding to the support system 530, configured to test the dynamic impact properties or static mechanical properties of the support system 530. The monitoring mechanism 600 communicates with the testing platform 500. It can well restore the layout of the bolt under the actual engineering support conditions, and not only can provide dynamic impact test conditions for the shotcrete-rock bolt-mesh support system through the dynamic impact testing mechanism, but also can choose to use the test loading mechanism to realize the static pressure test of the shotcrete-rock bolt-mesh support system. Two mechanisms share the main frame, lifting and lifting device, testing platform and monitoring system, which solves the technical problem that the existing testing apparatus has a single form and cannot accurately restore the layout of the bolt under the actual engineering support conditions.

For a more comprehensive understanding of the above technical scheme, an exemplary embodiment of the invention will be subsequently set forth in detail with reference to the accompanying drawing. It is to be understood that the invention may be implemented in various forms and should not be limited to the specific embodiment described herein. Instead, this embodiment is provided to offer a more clear and complete understanding of the invention, thereby fully conveying the scope thereof to persons skilled in the art.

### Example 1

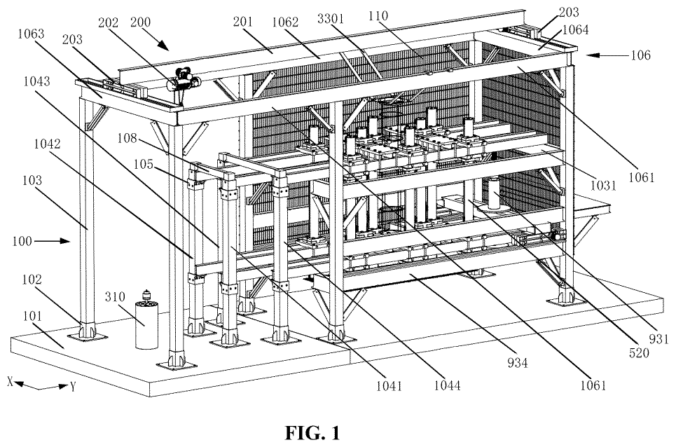

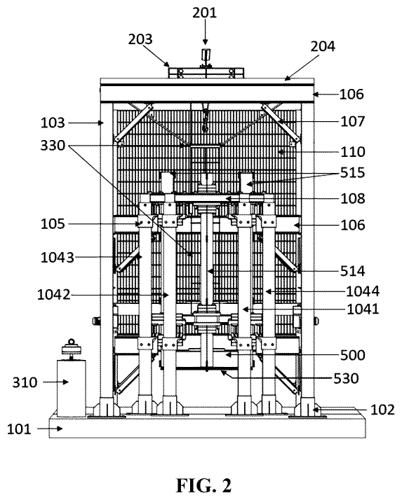

As shown in FIG. 1 and FIG. 2, the invention provides a testing apparatus for mechanical properties of shotcrete-rock bolt-mesh support system. In order to facilitate the expression, the “testing apparatus for mechanical properties of shotcrete-rock bolt-mesh support system” of the invention is referred to as “testing apparatus”. The testing apparatus includes: a host frame 100, a lifting and transporting mechanism 200, a mechanical testing mechanism, a testing platform 500 and a monitoring mechanism 600.

The lifting and transporting mechanism 200 is disposed on the main frame 100, and the lifting and transporting mechanism 200 can lift the testing platform 500. The testing platform 500 includes a mold group and a support system 530, the mold group is movablely disposed on the main frame 100, and the support system 530 is detachably disposed at the bottom of the mold group. The monitoring mechanism 600 communicates with the testing platform 500 to obtain the mechanical data of the mechanical testing mechanism for the support system 530.

In this embodiments, the mold group may be set in the testing platform 500 of the testing apparatus, that is, the mold group can move along the load transfer slide rail 109, so that in the process of use, not only can multiple anchors 901 be disposed meanwhile through the mold group to realize the multi-point anchoring of the steel mesh in the support system 530, but also the position of the mold group may be flexibly adjusted to adjust the arrangement spacing of the anchors to adapt to the steel mesh of different sizes, and the engineering practice may be simulated to realize the diamond pattern and square pattern of the anchor mounting. The testing apparatus can simulate the construction of a real support assembly through the mold group and the anchor rods of different specifications set in the mold group, the steel mesh in the support system 530, and the shotcrete. In this testing apparatus, the dynamic impact testing mechanism 300 and the test loading mechanism 900 may be used as the mechanical testing mechanism to test the mechanical properties of the support system 530, and the dynamic impact testing mechanism 300 and the test loading mechanism 900 may be replaced.

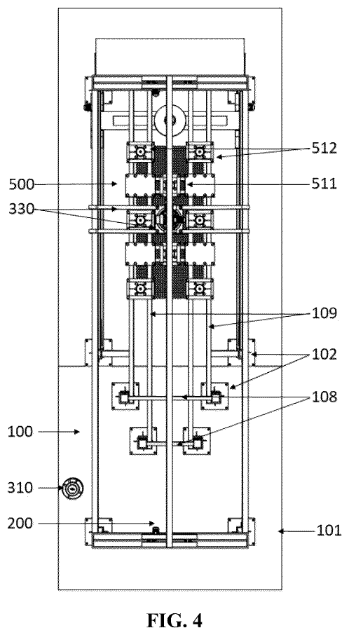

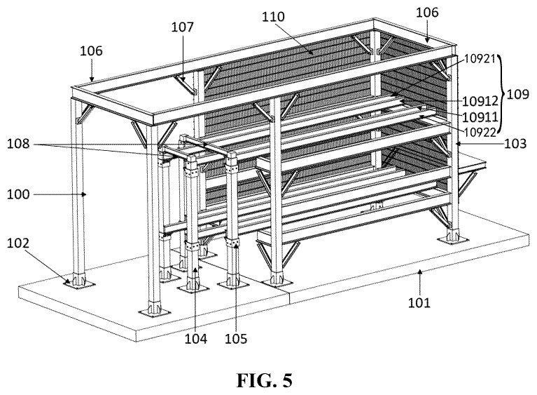

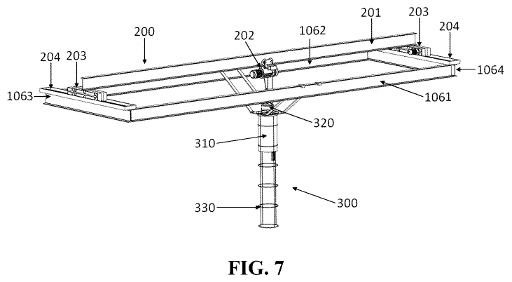

As shown in FIG. 3, FIG. 4, and FIG. 5, the main frame 100 includes pedestal 101, column base 102, frame column 103, platform column 104, column rail brace 105, frame beam 106, cap beam 108, and multiple sets of load transfer slide rails 109. The column base 102 is mounted on the pedestal 101, the end of the frame column 103 near the pedestal 101 is connected to the column base 102, the frame beam 106 is connected to the frame column 103, and the frame beam 106 is located on the upper or top of the frame column 103, preferably on the top of the frame column 103. In a preferred embodiment, the column base 102 is a square cylindrical structure, and the bottom is connected to a square tray. The square tray is provided with a bolt or anchor bolt hole, and the square tray may be fixed on the pedestal 101 by bolt or anchor bolt. The frame column 103 is preferably a square steel column, which is inserted and anchored in the column base 102. According to FIG. 1 and FIG. 7, the frame beam 106 includes the first connecting beam 1061, the second connecting beam 1062, the third connecting beam 1063 and the fourth connecting beam 1064. The first connecting beam 1061 and the second connecting beam 1062 are a set of relative connecting beams, and the third connecting beam 1063 and the fourth connecting beam 1064 are another set of relative connecting beams. The first connecting beam 1061 and the second connecting beam 1062 are arranged in parallel, the third connecting beam 1063 and the fourth connecting beam 1064 are arranged in parallel, and two ends of the first connecting beam 1061 and the second connecting beam 1062 are connected to the third connecting beam 1063 and the fourth connecting beam 1064.

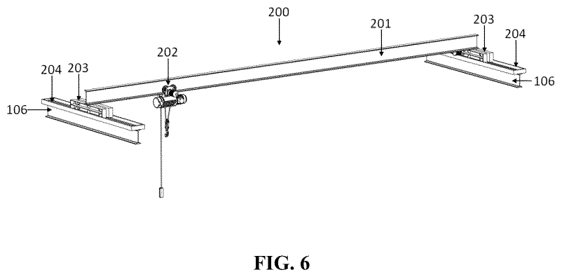

With reference to FIG. 1, FIG. 2 and FIG. 6, the lifting and transporting mechanism 200 is disposed on the frame beam 106, and the dynamic impact testing mechanism 300 in the mechanical testing mechanism may be disposed on the frame beam 106. One end of platform column 104 near pedestal 101 is disposed on pedestal 101 through column base 102. The setting mode of the platform column 104 may be selected as follows: The setting mode of the platform column 104 is shown in FIG. 1. That is, the top of the adjacent platform column 104 in the same vertical plane is connected by the cap beam 108, that is, two ends of the cap beam 108 may be disassembled and mounted in the adjacent platform column 104, and the “removable” here may be realized by the well-known way such as bolts. It should be noted that the “same vertical plane” described here refers to the plane where two adjacent platform columns 104 are located in the X direction shown in FIG. 1.

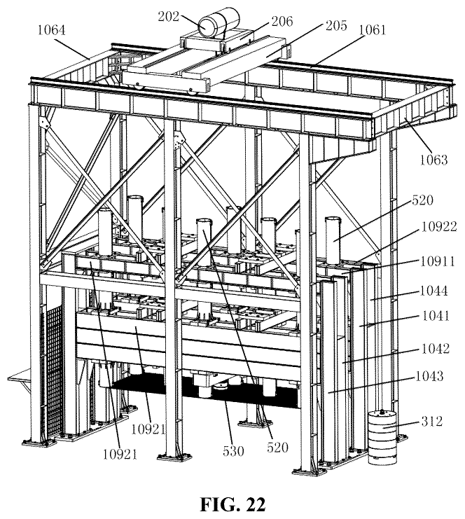

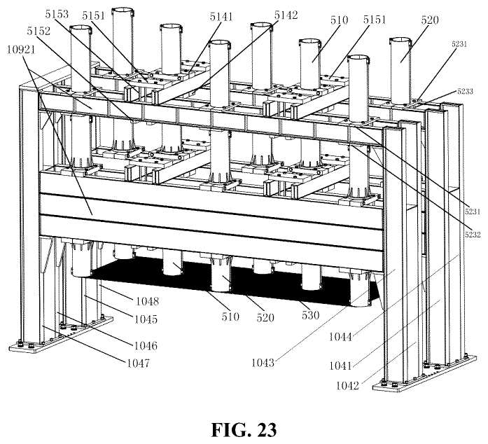

The second way of setting the platform column 104: Referring to FIG. 22 and FIG. 23, there is no cap beam 108 at the top of the adjacent platform columns 104. Frame beam 106 is preferably I-beam. In order to ensure the stability of the connection between the frame column 103 and the frame beam 106 in the main frame 100, the diagonal brace 107 is also set in the main frame 100, and the diagonal brace 107 is connected between the frame column 103 and the frame beam 106 at an angle of 45°.

The column rail brace 105 is disposed on the platform column 104, and the column rail brace 105 is used to support the load transfer slide rail 109. One end of the load transfer slide rail 109 is fixed between the frame beam 106 and the pedestal 101. The other end of the load transfer slide rail 109 is connected to the platform column 104 through the column rail brace 105. The sliding channel is formed between the adjacent load transfer slide rail 109. The mold group is disposed on the load transfer slide rail 109 and can slide along the load transfer slide rail 109. There may be two settings here for the load transfer slide rail 10. The first setting of the load transfer slide rail 109: Referring to FIG. 1, one end of the load transfer slide rail 109 may be connected to the frame column 103, and the other end is connected to the platform column 104. In this way, the connecting beam 1031 may be disposed on the frame column 103, and the connecting beam 1031 is connected to the load transfer slide rail 109. The second setting of the load transfer slide rail 109: Referring to FIG. 23, four auxiliary platform columns are also disposed on the pedestal 101, which are the first auxiliary platform column 1045, the second auxiliary platform column 1046, the third auxiliary platform column 1047 and the fourth auxiliary platform column 1048, respectively. The auxiliary platform column and the platform column 104 support the load transfer slide rail 109.

The load transfer slide rail 109 includes the first load transfer slide rail 1091 and the second load transfer slide rail 1092. The first load transfer slide rail 1091 and the second load transfer slide rail 1092 both include two parallel load transfer slide rails. Two parallel load transfer slide rails in the first load transfer slide rail 1091 are located on the same horizontal plane, and two parallel load transfer slide rails in the second load transfer slide rail 1092 are also located on the same horizontal plane.

When adopting the first setting of the platform column 104, the length of the second load transfer slide rail 1092 is less than the length of the first load transfer slide rail 1091.

When adopting the second setting of the platform column 104, the length of the second load transfer slide rail 1092 is the same as the length of the first load transfer slide rail 1091.

The main frame 100 is also equipped with a safety enclosure network 110, and the safety enclosure network 110 is surrounded on three sides in the main frame 100. The safety enclosure network 110 is connected to the frame beam 106 and the frame column 103 respectively to block the gravel splashed by the testing apparatus during the test process, thereby improving the safety of the testing apparatus and protecting the personal safety of the test personnel.

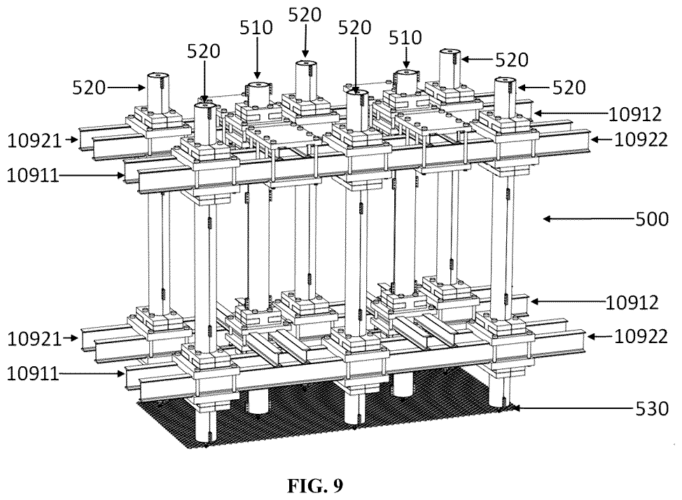

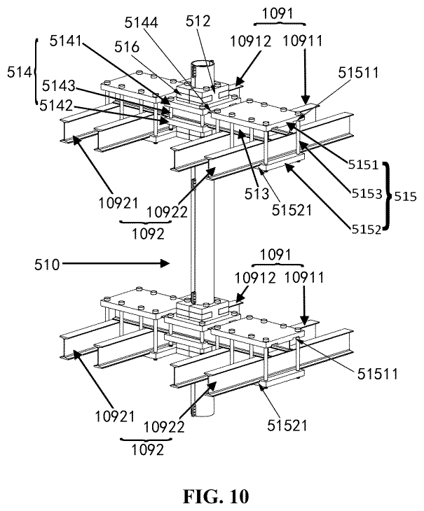

In some embodiments, referring to FIG. 5, FIG. 9 and FIG. 10, two parallel sub-force slides of the first sub-load transfer slide rail 1091 are the first sub-load transfer slide rail 10911 and the second sub-load transfer slide rail 10912, respectively. two parallel load transfer slide rails of the second load transfer slide rail 1092 are the third sub-load transfer slide rail 10921 and the fourth sub-load transfer slide rail 10922. The third sub-load transfer slide rail 10921 and the fourth sub-load transfer slide rail 10922 are disposed on both sides of the first sub-load transfer slide rail 10911 and the second sub-load transfer slide rail 10912. In the form shown in FIG. 5, the length of the third sub-load transfer slide rail 10921 and the fourth sub-load transfer slide rail 10922 is less than the length of the first sub-load transfer slide rail 10911 and the second sub-load transfer slide rail 10912, which is convenient for the mounting of the cap beam 108.

The first load transfer slide rails 1091 may be set in two with corresponding upper and lower positions. The second load transfer slide rail 1092 may also be set in two with corresponding upper and lower positions. The upper first sub-load transfer slide rail 10911 and the upper second sub-load transfer slide rail 10912 are located in the same horizontal plane as the upper third sub-load transfer slide rail 10921 and the upper fourth sub-load transfer slide rail 10922, while the lower first sub-load transfer slide rail 10911 and the lower second sub-load transfer slide rail 10912 are located in the same horizontal plane as the lower third sub-load transfer slide rail 10921 and the lower fourth sub-load transfer slide rail 10922.

Referring to FIG. 1 and FIG. 2, the platform column 104 is divided into four columns, namely, the first platform column 1041, the second platform column 1042, the third platform column 1043 and the fourth platform column 1044. The first sub-load transfer slide rail 10911 is connected to the first platform column 1041 through the column rail brace 105, the second sub-load transfer slide rail 10912 is connected to the second platform column 1042 through the column rail brace 105, the third sub-load transfer slide rail 10921 is connected to the third platform column 1043 through the column rail brace 105, and the fourth sub-load transfer slide rail 10922 is connected to the fourth platform column 1044 through the column rail brace 105.

When adopting the first setting of the platform column 104, the first platform column 1041 and the second platform column 1042 are located in the “same vertical plane”, and the third platform column 1043 and the fourth platform column 1044 are located in the “same vertical plane”. Such a setting makes the vertical plane of the first platform column 1041 and the second platform column 1042 staggered with the vertical plane of the third platform column 1043 and the fourth platform column 1044, which is convenient for the mounting of the cap beam 108.

When adopting the second setting of the platform column 104, the first platform column 1041, the second platform column 1042, the third platform column 1043 and the fourth platform column 1044 are all located in the same vertical plane. At this time, when adopting the second setting of the load transfer slide rail 109, the first platform column 1041 corresponds to the first sub-platform column 1045, the second platform column 1042 corresponds to the second sub-platform column 1046, the third platform column 1043 corresponds to the third sub-platform column 1047, and the fourth platform column 1044 corresponds to the fourth sub-platform column 1048.

In addition, escalator 121 may be installed between the first platform column 1041 and the second platform column 1042. The setting of escalator 121 makes the device more convenient for staff.

In the above embodiment, the load transfer slide rail 109 is disposed in the main frame 100, and the mold group is disposed on the load transfer slide rail 109, so that the mold group may move between the pedestal 101 and the frame beam 106 to simulate the mounting conditions in the actual project through appropriate adjustment. The first load transfer slide rail 1091 forms a sliding channel, while the left and right sides of the first load transfer slide rail 1091 and the second load transfer slide rail 1092 form sliding channels, respectively; the mold group is mounted in the sliding channel, the setting of the column rail support 105 makes the mounting of the load transfer slide rail 109 more convenient and quick.

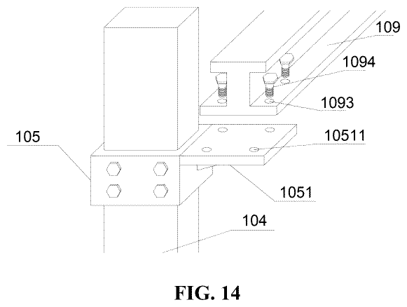

At the end of the platform column 104, the stability of the platform column 104 is enhanced by setting the detachable cap beam 108, which avoids the shaking of the testing platform 500 during the test. In a preferred way, the column rail support 105 is preferred to be a square tube structure. Referring to FIG. 14, the square tube structure is provided with a bolt hole. The square tube structure may be disposed on the platform column 104 and fixed with bolts. The extended plane 1051 is disposed on the top side of the square tube structure, which may be used as the connection plane of the load transfer slide rail 109, that is, the load transfer slide rail 109 may be fixed on the extended plane 1051 by installing bolts. For example, the bolt mounting hole 10511 with internal thread is disposed on the extended plane 1051, and the bolt hole 1093 is disposed on the load transfer slide rail 109. The mounting bolt 1094 is used to pass through the bolt hole 1093 and the bolt mounting hole 10511 in turn, so that the mounting bolt 1094 is matched with the bolt mounting hole 10511, furthermore, the detachable connection between the load transfer slide rail 109 and the extended plane 1051 is performed.

When adopting the second setting of the platform column 104, the first platform column 1041, the second platform column 1042, the third platform column 1043 and the fourth platform column 1044 are all located in the same vertical plane. At this time, adopting the second setting of the load transfer slide rail 109, the first platform column 1041 corresponds to the first sub-platform column 1045, the second platform column 1042 corresponds to the second sub-platform column 1046, the third platform column 1043 corresponds to the third sub-platform column 1047, and the fourth platform column 1044 corresponds to the fourth sub-platform column 1048.

In addition, escalator 121 may be installed between the first platform column 1041 and the second platform column 1042. The setting of escalator 121 makes the device more convenient for staff.

In the above embodiment, the load transfer slide rail 109 is set in the main frame 100, and the mold group is disposed on the load transfer slide rail 109, so that the mold group can move between the pedestal 101 and the frame beam 106 to simulate the mounting conditions in the actual project through appropriate adjustment. The first load transfer slide rail 1091 forms a sliding channel, while the left and right sides of the first load transfer slide rail 1091 and the second load transfer slide rail 1092 form sliding channels, respectively. The mold group is mounted in the sliding channel. The setting of the column rail support 105 makes the mounting of the load transfer slide rail 109 more convenient and quick.

At the end of the platform column 104, the stability of the platform column 104 is enhanced by setting the detachable cap beam 108, which avoids the shaking of the testing platform 500 during the test. In a preferred way, the column rail support 105 is preferred to be a square tube structure. Referring to FIG. 14, the square tube structure is provided with a bolt hole. The square tube structure may be disposed on the platform column 104 and fixed with bolts. The extended plane 1051 is disposed on the top side of the square tube structure, which may be used as the connection plane of the load transfer slide rail 109, that is, the load transfer slide rail 109 may be fixed on the extended plane 1051 by installing bolts. For example, the bolt mounting hole 10511 with internal thread is disposed on the extended plane 1051, and the bolt hole 1093 is disposed on the load transfer slide rail 109. The mounting bolt 1094 is used to pass through the bolt hole 1093 and the bolt mounting hole 10511 in turn, so that the mounting bolt 1094 is matched with the bolt mounting hole 10511. Furthermore, the detachable connection between the load transfer slide rail 109 and the extended plane 1051 is carried out.

The ends of the cap beam 108 are set as a square structure, and the cap beam 108 may be detachably connected to the platform column 104. For example, the blind hole of the internal thread bolt may be disposed at the top of the platform column 104, and the through hole may be disposed at the square structure at both ends of the cap beam 108. During mounting, the through hole at the square structure at both ends of the cap beam 108 corresponds to the blind hole of the internal thread bolt at the top of the platform column 104, and then the bolts are used to pass through the blind hole of the internal thread bolt at the top of the flat platform column 104, and the bolts are matched with the blind hole of the internal thread bolt at the top of the platform column 104. The cap beam 108 is then detachably connected to the top end of the platform column 104.

When lifting the inner mold 510 and the outer mold 520, the cap beam 108 may be disassembled to ensure that the sliding channel is unobstructed and the lifting process is carried out smoothly. After the lifting of the mold group is completed, the mounting of the cap beam 108 on the platform column 104 can increase the structural stability of the main frame 100.

Lifting and transporting mechanism 200 may be one of the following two forms:

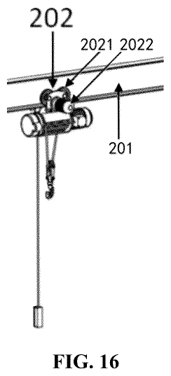

The first lifting and transporting mechanism 200: Referring to FIG. 6 and FIG. 7. Lifting and transporting mechanism 200 includes hoisting beam 201, lifting part 202, paired sliding bearing 203 and paired lateral slide 204. The paired lateral slide 204 is disposed on the third connecting beam 1063 and the fourth connecting beam 1064 respectively. The sliding supports 203 are disposed on the paired lateral slides 204 one by one. The two ends of the hoisting beam 201 are connected to a paired sliding bearing 203 respectively. The hoisting beam 201 is located between the first connecting beam 1061 and the second connecting beam 1062, and the lifting part 202 is disposed on the hoisting beam 201. In this embodiment, the lifting and transporting mechanism 200 may be lifted in the longitudinal Y direction and the lateral X direction meanwhile by the lifting part 202 installed by the sliding mounting and the paired sliding bearing 203 disposed on the paired lateral slide 204, which makes the lifting and transporting mechanism 200 flexible and convenient, and the lifting range is wide. In a preferred embodiment, the lifting part 202 is an electric hoist. The electric hoist is small in size, light in weight, simple in operation, easy to use and install. The lifting part 202 can also be a hoist. Taking the electric hoist as an example, referring to FIG. 16 (enlarged FIG. 6), the walking roller 2021 is disposed on the electric hoist. The walking roller 2021 can roll along the hoisting beam 201, and the walking roller 2021 is connected to the walking motor 2022. The walking motor 2022 drives the walking roller 2021 to roll along the hoisting beam 201, which in turn drives the entire electric hoist to move in the longitudinal Y direction along the hoisting beam 201. In this embodiment, the paired sliding bearing 203 is equipped with an electric motor, and the electric motor is sliding connected to the paired lateral slide 204, that is, the paired lateral slide 204 may be a chute, and the bottom of the paired sliding bearing 203 is equipped with a roller, which is connected to the electric motor. The start and stop of the electric motor controls the rolling of the roller, and then controls the sliding of the paired sliding bearing 203 on the paired lateral slide 204, while the sliding of the paired sliding bearing 203 on the paired lateral slide 204 drives the hoisting beam 201 to move horizontally in the lateral X direction.

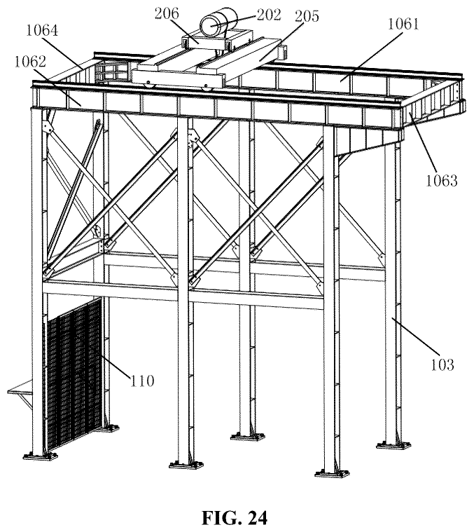

The second lifting and transporting mechanism 200: Referring to FIG. 22 and FIG. 24, lifting and transporting mechanism 200 includes lifting parts 202, longitudinal moving vehicle 205 and lateral moving vehicle 206. The first connecting beam 1061 and the second connecting beam 1062 are provided with a longitudinal chute at the top. The longitudinal moving vehicle 205 is extended into the longitudinal chute through the longitudinal moving roller and the longitudinal moving vehicle 205 is also provided with a longitudinal moving motor. The longitudinal moving motor is connected to one of the longitudinal moving rollers at the bottom of the longitudinal moving vehicle 205 to drive the longitudinal moving vehicle 205 to move along the first connecting beam 1061 and the second connecting beam 1062. A lateral chute is disposed on the top of the longitudinal moving vehicle 205, and the direction of the lateral chute is perpendicular to the direction of the longitudinal chute. A lateral roller is disposed at the bottom of the lateral moving vehicle 206, which extends into the lateral chute and can roll along the lateral chute. A lateral moving motor is disposed on the lateral moving vehicle 206, which is connected to one of the lateral moving rollers to drive the lateral moving vehicle 206 to move along the lateral chute. The middle of the longitudinal moving vehicle 205 and the lateral moving vehicle 206 is provided with a through hole for the spreader of the Lifting part 202, such as the hook.

In a preferred embodiment, the lifting part 202 is an electric hoist. The electric hoist is small in size, light in weight, simple in operation, easy to use and easy to install. The lifting part 202 can also be a hoist.

Referring to FIG. 9, the mold group includes the inner mold 510, the outer mold 520 and the test rock bolt. The inner mold 510 is disposed on the first load transfer slide rail 1091, and the outer mold 520 is disposed between the first load transfer slide rail 1091 and the second load transfer slide rail 1092. The detachable anchor to be tested is set in the inner mold 510 and the outer mold 520. The inner mold 510 and the outer mold 520 are hollow. The above-mentioned outer mold 520 and the inner mold 510 have a mold length of about 3.2 m, which may be driven into the longest bolt of about 3.2 m.

The support system includes the combined support of bolt and steel mesh and the combined support of bolt-shotcreting mesh.

In this embodiment, the number of inner mold 510 and outer mold 520 may be increased or decreased according to the actual needs in the process of use. The one-to-one detachable anchors to be tested are set in the inner mold 510 and outer mold 520. The interiors of the inner mold 510 and the outer mold 520 are hollow. The shell of the inner mold 510 and the outer mold 520 may be poured with concrete to simulate the surrounding rock conditions in engineering practice. After the concrete is solidified, the anchors to be tested are installed from the bottom of the inner mold 510 and the outer mold 520. According to the test requirements, the inner mold 510 and the outer mold 520 are disposed on the sliding channel formed by the load transfer slide rail 109. The anchor head of the anchor rod to be tested mounted in the inner mold 510 and the outer mold 520 may be mounted with a steel mesh, which is called the combined support of the anchor rod and the steel mesh. The inner mold 510 and the outer mold 520 are filled with concrete. In a preferred embodiment, the support system is the combined support of anchor, shotcrete and steel mesh. The combined support of anchor, shotcrete and steel mesh is a combined support structure of anchor, shotcrete and steel mesh. The combined support of anchor, shotcrete and steel mesh is suitable for poor stability and unstable surrounding rock, medium expansive soft surrounding rock, etc. Compared with the traditional anchor and shotcrete structure, the combined support of anchor, shotcrete and steel mesh increases the integrity and flexural, tensile and shear properties of shotcrete. This not only improves the supporting resistance of shotcrete, but also significantly improves the crack resistance of shotcrete layer, relatively reduces the thickness of shotcrete, and improves the flexibility and tightness of shotcrete layer. Meanwhile, the steel mesh in the shotcrete can also prevent cracks caused by shrinkage and improper maintenance, so that the spray layer pressure may be more evenly distributed.

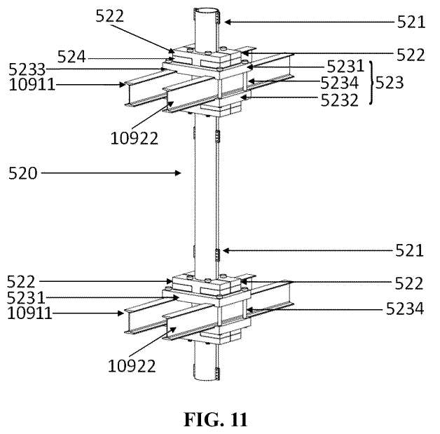

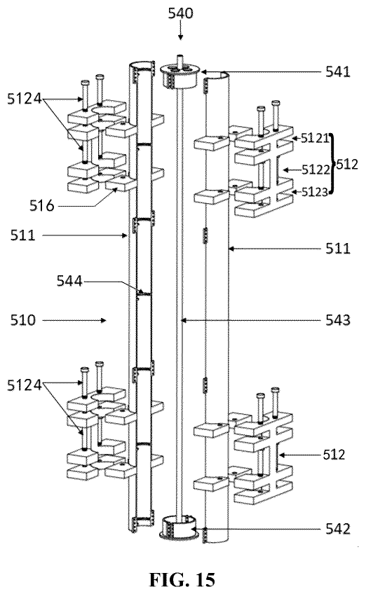

As shown in FIG. 10, FIG. 11 and FIG. 15, the inner mold 510 includes the inner mold shell, multiple symmetrically arranged inner mold fasteners 512, support beam 513, paired inner mold clamp plates 514 and paired track clamp plates 515, the inner mold clamp plate 514 includes the first clamp plate 5141 and the second clamp plate 5142 in a detachable connection, and the first clamp plate 5141 and the second clamp plate 5142 are arranged in parallel. The support beam 513 may be two I-beams, and the role of the inner mold clamp plate 514 is mainly used to locate two I-beams and the inner mold shell.

The way of positioning the inner mold 510 by the inner mold clamp plate 514 and the track clamp plate 515 may be one of the following two ways:

The first positioning method: According to FIG. 10, FIG. 11 and FIG. 15, the first clamp plate 5141 and the second clamp plate 5142 are located at the top and bottom of two I-beams of the support beam 513 respectively, and then two I-beams are clamped. The first clamp plate 5141 and the second clamp plate 5142 are provided with the first positioning groove 5144 for accommodating the insertion of two I-beams to ensure the stability between two I-beams, meanwhile, two I-beams may be kept always parallel so as not to affect the use. In addition, two I-beams can only be lapped on the first sub-load transfer slide rail 10911 and the second sub-load transfer slide rail 10912, and can also be lapped on the first sub-load transfer slide rail 10911, the second sub-load transfer slide rail 10912, the third sub-load transfer slide rail 10921 and the fourth sub-load transfer slide rail 10922. A detachable connection between the first clamp plate 5141 and the second clamp plate 5142 through the inner clamp plate connecting bolt 5143. The form of the inner mold fastener 512 is shown in FIG. 15. Three grooves are disposed on both sides of the inner mold fastener 512. The three grooves are the upper inner mold clamping groove 5121, the middle inner mold clamping groove 5122 and the lower inner mold clamping groove 5123, respectively. The inner mold card 516 is disposed on the inner mold shell. The inner mold card 516 is mainly used to clamp the upper inner mold clamping groove 5121 and the lower inner mold clamping groove 5123, while the middle inner mold clamping groove 5122 is used to pass through two I-beams of the support beam 513. The inner mold fastener 512 and the inner mold card 516 are detachably connected by the internal fastener bolt 5124. A through hole for the inner mold shell and the inner mold fastener 512 is disposed on the inner mold clamp plate 514, that is, the inner mold clamp plate 514 is set outside the inner mold fastener 512 and the inner mold card 516, and then the inner mold fastener 512 and the inner mold card 516 are limited, and then the inner mold shell is limited. Preferably, the internal size of the through hole on the inner mold clamp plate 514 meets the requirement that it may be set outside the inner mold fastener 512 and the inner mold card 516. It should be noted that the outer wall of the inner mold card 516 is not protruding from the outer wall of the inner mold fastener 512, and is preferably aligned with the outer wall of the inner mold fastener 512.

The track clamp plate 515 includes the first track clamp plate 5151 and the second track clamp plate 5152, and the first track clamp plate 5151 and the second track clamp plate 5152 are set in parallel. The track clamp plate 515 is used to clamp the support beam 513 and the load transfer slide rail. Meanwhile, two I-beams of the support beam 513 are lapped on the first sub-load transfer slide rail 10911, the second sub-load transfer slide rail 10912, the third sub-load transfer slide rail 10921 and the fourth sub-load transfer slide rail 10922. The track clamp plate 515 is divided into two groups. Two groups of track clamp plates 515 are located on both sides of the inner mold shell. The first track clamp plate 5151 and the second track clamp plate 5152 of the track clamp plate 515 are clamped on the side of the inner mold shell with the first sub-load transfer slide rail 10911 and the fourth sub-load transfer slide rail 10922. That is, the first track clamp plate 5151 is located at the top of two I-beams. The bottom of the first track clamp plate 5151 is provided with a second positioning groove 51511 for clamping two I-beams, while the second track clamp plate 5152 is located at the bottom of the first sub-load transfer slide rail 10911 and the third sub-load transfer slide rail 10921. The top surface of the second track clamp plate 5152 is provided with a third positioning groove 51521 for clamping the first sub-load transfer slide rail 10911 and the fourth sub-load transfer slide rail 10922. There is a detachable connection between the first rail clamp plate 5151 and the second rail clamp plate 5152 through the rail clamp plate bolt 5153. Similarly, the first track clamp plate 5151 and the second track clamp plate 5152 of the other set of track clamp plate 515 will clamp two I-beams on the other side of the inner mold shell with the second load transfer slide rail 10912 and the third load transfer slide rails 10921.

### The Second Positioning Method:

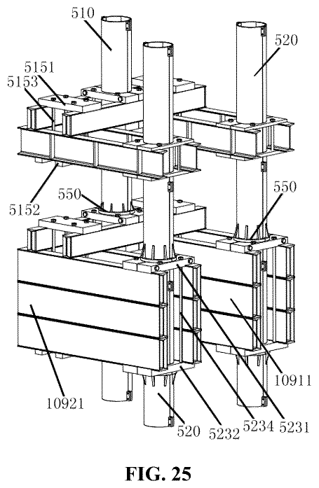

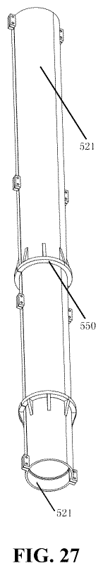

Refer to FIG. 23, FIG. 25 and FIG. 27, the first clamp plate 5141 and the second clamp plate 5142 are located at the top and bottom of two I-beams respectively, and then two I-beams are clamped to ensure the stability between two I-beams. In this way, the outer wall of the inner mold shell is provided with a clamping flange 550, and the clamping flange 550 is at least one group, and each group is the corresponding upper and lower two. The top of the first clamp plate 5141 supports a set of clamping flanges 550 in the upper part of the clamping flange 550, while the bottom of the second clamp plate 5142 contacts the top surface of the clamping flange 550 in the lower part, so that the mold shell is positioned. In addition, two I-beams of the support beam 513 may only be lapped on the first sub-load transfer slide rail 10911 and the second sub-load transfer slide rail 10912, and may also be lapped on the first sub-load transfer slide rail 10911, the second sub-load transfer slide rail 10912, the third sub-load transfer slide rail 10921 and the fourth sub-load transfer slide rail 10922. A detachable connection between the first clamp plate 5141 and the second clamp plate 5142 through an internal clamp plate connecting bolt.

The track clamp plate 515 includes the first track clamp plate 5151 and the second track clamp plate 5152, and the first track clamp plate 5151 and the second track clamp plate 5152 are set in parallel. The track clamp plate 515 is used to clamp the support beam 513 and the load transfer slide rail. Meanwhile, two I-beams of the support beam 513 are lapped on the first sub-load transfer slide rail 10911, the second sub-load transfer slide rail 10912, the third sub-load transfer slide rail 10921 and the fourth sub-load transfer slide rail 10922. The track clamp plate 515 is divided into two groups. Two groups of track clamp plates 515 are located on both sides of the inner mold shell. The first track clamp plate 5151 and the second track clamp plate 5152 of the track clamp plate 515 are clamped on the side of the inner mold shell with the first sub-load transfer slide rail 10911 and the fourth sub-load transfer slide rail 10922. That is, the first track clamp plate 5151 is located at the top of two I-beams, while the second track clamp plate 5152 is located at the bottom of the first sub-load transfer slide rail 10911 and the fourth sub-load transfer slide rail 10922. A detachable connection between the first rail clamp plate 5151 and the second rail clamp plate 5152 through the rail clamp plate bolt 5153. Similarly, the first track clamp plate 5151 and the second track clamp plate 5152 of the other set of track clamp plate 515 will clamp two I-beams on the other side of the inner mold shell with the second load transfer slide rail 10912 and the third load transfer slide rails 10921.

The detachable inner mold shell is set in the sliding channel formed by the first sub-load transfer slide rail 10911 and the second sub-load transfer slide rail 10912. The inner mold fastener 512 is connected to the inner mold shell. Further, two inner mold fasteners 512 symmetrically set in the same horizontal plane are connected to clamp the inner mold. In this way, the inner side of the inner mold fastener 512 may be set to adapt to the shape of the outer wall of the inner mold shell. When two inner mold fasteners 512 symmetrically set in the same horizontal plane are connected, the openings of two inner mold fasteners 512 just form a channel for the inner mold shell to pass through.

The outer mold 520 includes an outer mold shell, a plurality of symmetrically set outer mold fasteners 522, and a paired outer mold clamp plate 523. The outer mold clamp plate 523 includes the third clamp plate 5231 and the fourth clamp plate 5232 in a detachable connection, and the third clamp plate 5231 and the fourth clamp plate 5232 are arranged in parallel. The outer mold clamp plate 523 is mainly used for the outer mold shell to be mounted in the sliding channel formed between the first load transfer slide rail 1091 and the second load transfer slide rail 1092, that is, the outer mold shell is set in the sliding channel formed between the first load transfer slide rail 1091 and the second load transfer slide rail 1092. The outer mold shell is disposed between the first sub-load transfer slide rail 10911 and the fourth sub-load transfer slide rail 10922 as an example. The positioning method of the outer mold shell may be used in one of the following ways:

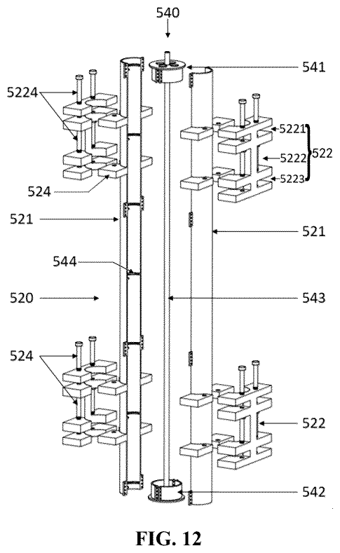

The first positioning method: Referring to FIG. 11 and FIG. 12, the third clamp plate 5231 and the fourth clamp plate 5232 are located at the top and bottom of the first power transmission slide rail 10911 and the fourth power transmission slide rail 10922, respectively. At the bottom of the third clamp plate 5231 and the top of the fourth clamp plate 5232, there is a fourth positioning groove 5233 to accommodate the insertion of the first power transmission slide rail 10911 and the fourth power transmission slide rail 10922. A detachable connection between the third clamp plate 5231 and the fourth clamp plate 5232 through the outer clamp plate connecting bolt 5234. The outer mold fastener 522 is connected to the outer mold shell, and two outer mold fasteners 522 symmetrically set in the same horizontal plane are connected to each other. In this way, a gap suitable for the outer wall shape of the outer mold shell may be disposed on the inner side of the outer mold fastener 522. When two outer mold fasteners 522 symmetrically set in the same horizontal plane are connected, the gap of two outer mold fasteners 522 just forms a channel for the outer mold shell to pass through. The form of the outer mold fastener 522 is shown in FIG. 12. Three grooves are disposed on both sides of the outer mold fastener 522. The three grooves are the upper outer mold clamping groove 5221, the middle outer mold clamping groove 5222 and the lower outer mold clamping groove 5223, respectively. The outer mold card 524 is disposed on the outer mold shell. The outer mold card 524 is mainly used to clamp the upper outer mold clamping groove 5221 and the lower outer mold clamping groove 5223, while the middle outer mold clamping groove 5222 is used for the first sub-load transfer slide rail 10911 and the fourth sub-load transfer slide rail 10922 to pass through. The outer mold fastener 522 and the outer mold card 524 are connected by the outer fastener bolt 5224. In addition, a through hole for the outer mold shell and the outer mold fastener 522 is disposed on the outer mold clamp plate 523, that is, the outer mold clamp plate 523 is set outside the outer mold fastener 522 and the outer mold card 524, and then the outer mold fastener 522 and the outer mold card 524 are limited, and then the inner mold shell is limited. In this way, the outer mold card 524 is not protruding from the outer mold fastener 522, and the outer wall of the outer mold card 524 is preferably aligned with the outer wall of the outer mold fastener 522. Preferably, the internal size of the through hole on the outer mold clamp plate 523 may be set outside the outer mold fastener 522 and the outer mold card 524.

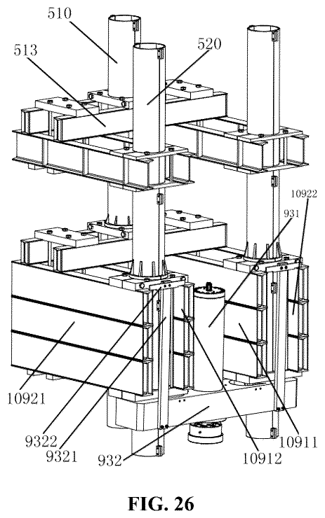

The second positioning method: According to FIG. 23, FIG. 25, FIG. 26 and FIG. 27, the third clamp plate 5231 and the fourth clamp plate 5232 are located at the top and bottom of the first and fourth load transfer slide rails 10911 and 10922, respectively. A detachable connection between the third clamp plate 5231 and the fourth clamp plate 5232 through the outer clamp plate connecting bolt 5234. In this way, the clamping flange 550 is disposed on the outer wall of the outer and inner mold shell. At least one group of the clamping flanges 550 is provided, and each group includes clamping flanges in the upper and lower positions corresponding to each other. The top of the third clamp plate 5231 supports the upper clamping flange 550 in a group of clamping flanges 550, while the bottom of the fourth clamp plate 5232 contacts the top surface of the lower clamping flange 550, so that the outer mold shell is positioned.

In some embodiments, in this embodiment, referring to FIG. 15, the inner mold shell is composed of two symmetrical half molds of the inner mold 511 corresponding connections. Referring to FIG. 12, the outer mold shell is composed of symmetrical half molds of the outer mold 521 in a corresponding connection. In order to prevent the displacement of concrete relative to the inner wall of the inner mold shell and the inner wall of the outer mold shell during the test, the anti-skid rib 544 is set in the half molds of the outer mold 521 and the half molds of the inner mold 511, which affects the accuracy of the test. The first positioning groove 5144, the second positioning groove 51511, the third positioning groove 51521 and the fourth positioning groove 5233, etc. make the inner mold clamp plate 514, the track clamp plate 515, the outer mold clamp plate 523, etc. easy to install and improve the stability after mounting.

The detachable setting on the mold group has a pouring accessory 540, that is, the inner mold 510 and the outer mold 520 are detachable disposed with a pouring accessory 540, and the setting method is the same.

Referring to FIG. 12, for example, the pouring accessory 540 is disposed on the outer mold 520: the pouring accessory 540 includes the top cover 541 and the bottom cover 542. The top cover 541 is connected to one end of the outer mold 520, and the bottom cover 542 is connected to the other end of the outer mold 520. In a preferred embodiment, the pouring accessory 540 also includes a hole tube 543, which is set in the outer mold shell. One end of the hole tube 543 is connected to the bottom cover 542, and the other end of the hole tube 543 is connected to the top cover 541. The inner cavity of 543 needs to be connected to the outside through the top cover 541 and the bottom cover 542.

The hole tube 543 is used to disposed in the inner mold shell and the outer mold shell when pouring concrete into the inner mold 510 and the outer mold 520. The hole tube 543 can prevent the liquid concrete from exposing from the top cover 541 and the bottom cover 542, because if the hole tube 543 is not disposed, holes need to be disposed on the top cover 541 and the bottom cover 542 in order to ensure the mounting of subsequent bolts. Meanwhile, the hole tube 543 can form a reserved hole without additional drilling, which is convenient for the subsequent mounting of the bolt. The hole tube 543 is removed after concrete pouring and forming to form a reserved hole for bolt connection. The use of the hole tube 543 eliminates the subsequent drilling process, speeds up the mounting of the testing apparatus, and improves the efficiency. However, in the test process, the hole tube 543 can also be not set during the pouring, and the bolt drilling rig is used to install the bolt to simulate the actual bolt drilling process.

In addition, the mechanical testing mechanism of the invention is selected for the dynamic impact testing mechanism 300 or the test loading mechanism 900.

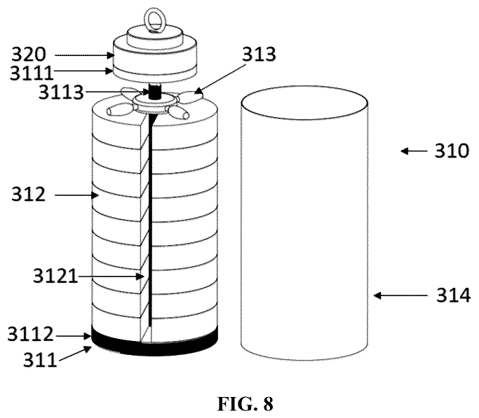

As shown in FIG. 7 and FIG. 8, when the dynamic impact testing mechanism 300 is used, the dynamic impact testing mechanism 300 is disposed on the main frame 100. The dynamic impact testing mechanism 300 can provide the impact force required for the dynamic impact properties test of the testing platform 500.

The dynamic impact testing mechanism 300 includes an impact weight 310, a crane 320 and a guide frame 330.

The guide frame 330 is connected to the frame beam 106. Furthermore, the top of the guide frame 330 is hung on the first connecting beam 1061 and the second connecting beam 1062 through a detachable hook 3301. The central axis of the guide frame 330 may be located in the same vertical plane as the lifting central axis of the lifting part 202. The “lifting central axis” described here is the central axis of the lifting part 202 when it works. The impact weight 310 may be connected to the lifting part 202 in the lifting and transporting mechanism 200, and the impact weight 310 may be detachably connected to the crane 320. The impact weight 310 is disposed on the guide frame 330 and may be moved along the guide frame 330. The bottom end of the guide frame 330 corresponds to the support system 530. The impact weight 310 includes a weight frame 311, a weight 312, a locking wheel 313 and a protective cylinder 314. The locking wheel 313 is connected to the weight frame 311, and the weight 312 is installed between the weight frame 311 and the locking wheel 313. The bottom surface of the locking wheel 313 is connected to the weight 312, and the protective cylinder 314 is connected to the weight frame 311 and disposed at the periphery of the weight 312.

In this embodiment, the crane 320 is preferably a power-off electromagnetic crane 320. When the power-off electromagnetic crane 320 is not energized, the electromagnetic crane 320 can continuously maintain its suction and avoid the impact weight 310 from falling. In the energized state, the electromagnetic crane 320 loses its suction and the impact weight 310 falls. The use of the power-off electromagnetic crane 320 can prevent the sudden power failure during the test, this failure may lead to the power failure of the impact weight 310, thereby improving the stability and safety of the testing apparatus. The setting of the power-off electromagnetic crane 320 can also maintain the suction for a long time without consuming electricity, effectively saving energy consumption and improving economy. During the test, the impact weight 310 and the electromagnetic crane 320 are in a detachable connection, that is, connected by suction. By lifting the lifting part 202 in the lifting and transporting mechanism 200, the impact weight 310 is lifted to the top of the impact zone of the dynamic impact test to provide the impact force required for the dynamic impact test, and the impact weight 310 may be correspondingly disposed on the guide frame 330. The setting of the guide frame 330 avoids the impact weight 310 from deviating from the established trajectory due to the external environment during the test, which further improves the stability of the dynamic impact testing mechanism 300 and avoids device damage. Furthermore, the guide frame 330 in this embodiment may be a cylindrical structure. Referring to FIG. 7, it may be a cage-like cylindrical structure surrounded by steel bars, and of course, it can also use other known forms of cylindrical structure. In use, the impact weight 310 is lifted to the upper end of the guide frame 330 of the cylindrical structure by lifting part 202, and the lower end is extended into the upper end of the cylindrical structure, so during the test, the impact weight 310 may slide down inside the guide frame 330 from the upper end of the guide frame 330 until it is rushed out from the lower end of the guide frame 330 to complete the test. Referring to FIG. 8, the hanging ring may be disposed on the top of the electromagnetic crane 320, and the lifting part 202 hooks the hanging ring through the hook to lift the impact weight 310.

Furthermore, for the impact weight 310, the weight frame 311 is an integrated assembly, which consists of two relative discs and a connecting shaft 3113, and two discs are the upper disc 3111 and the lower disc 3112, respectively. The upper disc 3111 provides a suction surface for the crane 320, the lower disc 3112 carries the weight 312 and the side of the lower disc 3112 is provided with a thread line. The connecting shaft 3113 is connected to the upper disc 3111 and the lower disc 3112, and the shaft body of the connecting shaft 3113 is provided with a thread line. The weight 312 may be detachably connected to the weight frame 311, and the weight 312 may be designed with a round cake-shaped opening, that is, a gap 3121 is disposed on the round cake-shaped weight 312 to facilitate the increase and decrease of the weight 312, thereby realizing the weight increase and decrease of the impact weight 310. According to the principle of the increase and decrease of weight 312, referring to FIG. 8, the weight 312 is disposed on the coupling 3113 through the gap 3121.

The inner ring of the locking wheel 313 is provided with a thread line, and is connected to the connecting shaft 3113 coaxial thread of the weight frame 311. By screwing the locking wheel 313, the locking wheel 313 moves along the connecting shaft 3113, so that the locking wheel 313 can press the weight 312. The protective cylinder 314 is wrapped outside the weight frame 311, and the weight 312 is also wrapped in it. A thread line is arranged at the bottom of the inner cavity side wall of the protective cylinder 314, and the protective cylinder 314 is matched with the thread line on the side of the lower disc 3112 through the thread line. In order to ensure the thread connection between the protective cylinder 314 and the lower disc 3112, the diameter of the weight 312 is not greater than the diameter of the lower disc 3112.

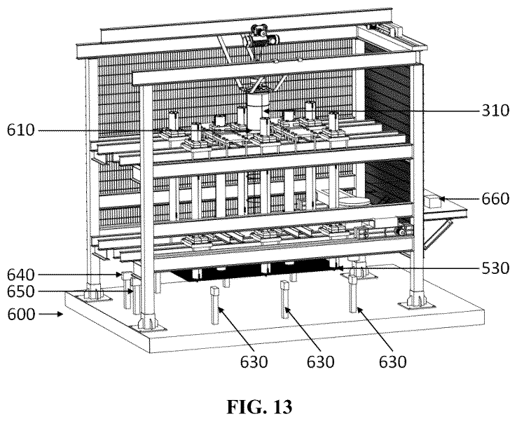

As shown in FIG. 13, for the dynamic impact testing mechanism 300: the monitoring mechanism 600 includes a dynamic impact force monitor 610, a displacement monitor 630, an image collector 640, a thermal energy monitor 650, a data acquisition and a display 660. The dynamic impact force monitor 610 is disposed at the bottom of the impact weight 310 or at the side of the support system 530 near the load transfer slide rail 109. The displacement monitor 630 is disposed on the pedestal 101 to monitor the displacement of the support system 530. The displacement monitor 630 may be disposed below the support system 530, and the support system 530 may be a steel mesh. The image collector 640 is disposed on the pedestal 101, and the thermal energy monitor 650 corresponds to the 530 setting of the support system, the dynamic impact force monitor 610, the displacement monitor 630, the image collector 640 and the thermal energy monitor 650 are all connected to the data acquisition and display 660.

In this embodiment, the dynamic impact force monitor 610 is preferably an impact force sensor, which is installed at the bottom of the impact weight 310 or disposed on the side of the impact force of the support system 530. The impact force sensor is used to monitor the impact force provided by the impact weight 310, and the dynamic impact force monitor 610 can also be a strain force sensor. The displacement monitor 630 is preferably a laser displacement meter. The laser displacement meter is disposed on the pedestal 101 to monitor the displacement of the support system 530. The displacement monitor 630 can also be an inductive displacement sensor or potentiometer displacement sensor. The image collector 640 is preferred as a high-speed camera. The high-speed camera is installed below the testing platform 500 to collect the image information of the supporting mechanism to be tested during the test. The image collector 640 can also be a scanner. The thermal energy monitor 650 is preferably an infrared thermal imager, which is disposed on the side of the support system 530 under the testing platform 500 to collect the thermal energy change of the support system 530. Data acquisition and display 660 includes signal conditioner, data acquisition card and computer, configured to collect and visualize the force, displacement, image information and thermal energy changes of the support system 530.

During the dynamic impact test, the concrete is poured into the inner mold shell and the outer mold shell of the mold group. after concrete curing, the hole tube 543 is removed, so that the hole for the test rock bolt will be formed at the position of the original hole tube 543, and then the test rock bolt will be mounted in the hole to complete the work of the test rock bolt mounted in the mold group. When the test rock bolt is mounted in the mold group, the mold group is disposed on the load transfer slide rail 109, so that the test rock bolt is connected to the support system 530.

According to the position of the testing platform 500, the impact area of the dynamic impact test is determined, and the guide frame 330 is installed, so that the guide frame 330 corresponds to the impact area, and the guide frame 330 is hung on the frame beam 106 through the hook 3301. The crane 320 is connected to the lifting and transporting mechanism 200, and the impact weight 310 of the corresponding mass is set according to the test requirements, and it is connected to the crane 320.

In the dynamic impact properties test, the impact weight 310 is lifted from the lifting and transporting mechanism 200 to the position of the guide frame 330, and the impact weight 310 coincides with the center axis of the guide frame 330. The crane 320 releases the impact weight 310, so that the potential energy generated by the free fall of the impact weight 310 acts on the impact area of the support system 530, and the monitoring agency 600 records the test data. Among them, the dynamic impact force monitor 610 and the displacement monitor 630 process the force signal and the impact displacement signal at the moment of impact through data acquisition and display 660 for signal processing, and transmit them to the computer for storage and analysis for subsequent test data analysis and processing, so as to accurately analyze the supporting properties of the support system 530 under dynamic impact. The image collector 640 and the thermal energy monitor 650 collect and visualize the image information and thermal energy changes.

Aiming at the test loading mechanism 900, the test loading mechanism 900 is set in the main frame 100, and the monitoring mechanism is connected to the lifting and transporting mechanism 200 and the test loading mechanism 900 respectively. In this embodiment, through the setting of the test loading mechanism 900, the testing apparatus can adjust any loading position through the longitudinal moving support 933 during the use process. The pier anchor system composed of anchor pier 923 can realize the test of single support system 530 or support system 530+shotcrete, and can also realize the test of support system 530+bolt and support system 530+bolt+shotcrete. It provides evaluation for various anchoring forms of practical engineering and has important on-site guiding significance. Moreover, the setting of the lifting and transporting mechanism 200 can transport the mold to any desired position to test the full-scale support composite structure of any commonly used anchorage spacing.

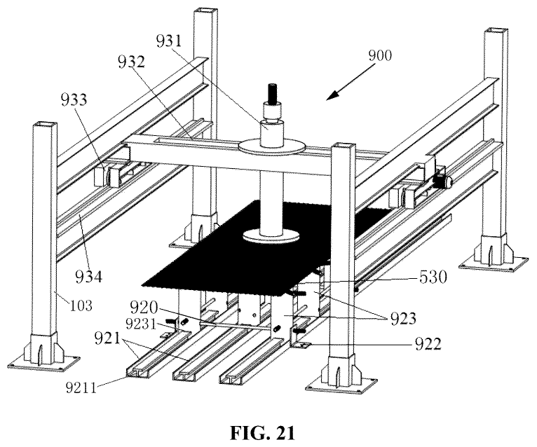

In a preferred embodiment, as shown in FIG. 21, the test loading mechanism 900 includes a servo hydraulic jack 931 and a longitudinal slide rail 934, the servo hydraulic jack 931 may be set in one of the following ways:

The first setting mode of servo hydraulic jack 931 is as follows: Referring to FIG. 21, the longitudinal slide rail 934 is disposed on the frame column 103, and the longitudinal slide rail 934 is set with the longitudinal moving support 933, the servo hydraulic jack 931 is detachable disposed on the longitudinal moving support 933 through the bearing beam 932, the servo hydraulic jack 931 and the bearing beam 932 may be disposed in the form of “detachable” and the bearing beam 932 and the longitudinal moving support 933 can also be disposed in the form of “detachable”. Here, the “detachable” may be used in any known detachable way, such as bolt connection, etc., which is not described here.

In this embodiment, the bearing beam 932 is disposed on the longitudinal moving support 933, and the longitudinal moving support 933 is provided with an electric motor and a pulley, so that the longitudinal moving support 933 can slide freely on the longitudinal slide rail 934. The servo hydraulic jack 931 is disposed on the bearing beam 932, and its bottom is a replaceable indenter for applying static force. The through hole may be disposed on the bearing beam 932 to facilitate the servo hydraulic jack 931 and the mold to pass through.

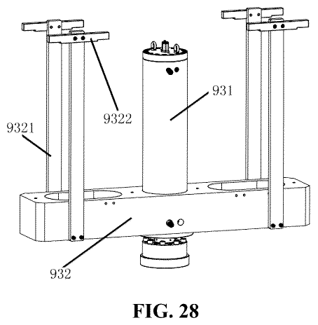

The second setting mode of servo hydraulic jack 931 is shown in FIG. 26 and FIG. 28. According to FIG. 26 and FIG. 28, the servo hydraulic jack 931 is disposed on the bearing beam 932, and the vertical reinforcement 9321 is disposed at both ends of the bearing beam 932. The top of the vertical reinforcement 9321 is disposed with the reinforcement hook 9322. The vertical reinforcement 9321 is located in the sliding channel formed between the first load transfer slide rail 1091 and the second load transfer slide rail 1092, that is, according to FIG. 26, the first load transfer slide rail 1091 and the second load transfer slide rail 1092 are both upper and lower groups. The vertical reinforcement 9321 at one end of the bearing beam 932 is located between the second sub-load transfer slide rail 10912 below and the third sub-load transfer slide rail 10921 below, and the tendon hook 9322 corresponding to the vertical reinforcement 9321 is connected to the second sub-load transfer slide rail 10912 below and the third sub-load transfer slide rail 10921 below. The vertical reinforcement 9321 at the other end of the bearing beam 932 is located between the first sub-load transfer slide rail 10911 and the fourth sub-load transfer slide rail 10922 below, and the tendon hook 9322 corresponding to the vertical reinforcement 9321 is hooked on the first sub-load transfer slide rail 10911 and the fourth sub-load transfer slide rail 10922 below. In this way, the first sub-load transfer slide rail 10911, the second sub-load transfer slide rail 10912, the third sub-load transfer slide rail 10921 and the fourth sub-load transfer slide rail 10922 located below may be larger than the first sub-load transfer slide rail 10911, the second sub-load transfer slide rail 10912, the third sub-load transfer slide rail 10921 and the fourth sub-load transfer slide rail 10922 in the vertical thickness.

Referring FIG. 21, the bottom of the servo hydraulic jack 931 is connected to the steel mesh of the support system 530, configured to test the loading force of the support system 530. The servo hydraulic jack 931 and the longitudinal mobile bearing 933 are connected to the monitoring mechanism. The anchor pier 923 is disposed at the bottom of the support system 530, and the anchor pier 923 is disposed on the pier anchor slide rail 921.

In some embodiments, see FIG. 21, Anchoring pier 923 and pier anchor slide rail 921 constitute a pier anchor assembly, pier anchor slide rail 921 is disposed on the pedestal 101, and anchor pier 923 may be disassembled and disposed on the pier anchor slide rail 921. The “detachable” here refers to that the anchor pier 923 may be separated from the pier anchor slide rail 921 and may be used in any known way. For example, the anchor pier 923 may be directly slipped from the end of the pier anchor slide rail 921. There is also an anchoring hole for installing the steel mesh of the support system 530 on the anchoring pier 923, and at least a pair of anchoring piers 923 may be fixed on the anchoring slideway through the anchoring plate 922. In addition, in order to be stable, the anchoring pier 923 may be connected by connecting rod 920, and the anchoring pier 923 to be connected may be selected according to the needs.

In this embodiment, the pier anchor slide rail 921 is disposed at least three groups, and the three groups of pier anchor slide rail 921 are set parallel to each other on the pedestal 101. The pier anchor slide rail 921 may be disposed in a groove shape, in which the mounting beam 9211 is disposed in the groove, and the mounting beam is preferably T-beam. The anchoring pier 923 may be a cylindrical structure. The bottom of the anchoring pier 923 is provided with a mounting gap 9231 which is connected to the mounting beam 9211, so that the anchoring pier 923 can slide freely in the pier anchor slide rail 921. Moreover, the number and location of the anchoring pier 923 may be set as needed to enable the pier anchor assembly to smoothly hang the steel mesh of the support system 530.

In the method for the test loading mechanism 900, the support system 530 is a steel mesh. The monitoring institutions include a pressure monitor, a displacement monitor, an image collector, a thermal energy monitor, and a data acquisition display. The pressure monitor is disposed on the side of the steel mesh near the load transfer slide rail 109, the displacement monitor is disposed on the pedestal 101 to monitor the displacement of the steel mesh, the image collector is disposed on the pedestal 101, and the thermal energy monitor is disposed corresponding to the steel mesh. The monitor, displacement monitor, image collector and thermal energy monitor are all connected to the data acquisition display.

In some embodiments, the tested object, namely the support system 530, is taken as an example of a single steel mesh. The main structures required for the test are loading assembly such as servo hydraulic jack 931 and pier anchor assembly. Before the test, the anchoring pier 923 is first slid into the appropriate position on the pier anchor slide rail 921. If there are three anchoring piers 923 on the pier anchor slide rail 921 on both sides of the pier anchor slide rail 921, and two anchoring piers 923 are located in the middle pier anchor slide rail 921, the “3-2-3” anchoring pier 923 test scheme is formed. Similarly, the “4-3-4” anchoring pier 923 test scheme may also be formed. In addition, the steel mesh of the support system 530 may be anchored to the threaded hole of the anchoring pier 923 by bolts. A pressure sensor is disposed between the anchoring pier 923 and the bolts. The pressure sensor is connected to the control monitoring system to obtain the required pre-tightening force. The metal network is equipped with a displacement sensor, and the communication is connected to the monitoring mechanism. During the experiment, the displacement data information of each part of the metal network may be obtained in real time.

On the basis of the above implementation, further, on the pedestal 101, multiple laser displacement meters may be set around the steel mesh, communicate and connect the control monitoring system to comprehensively monitor the deformation morphology of the bottom of the steel mesh. Finally, the bearing beam 932 is slid into the appropriate loading position, the servo hydraulic jack 931 applies a downward static load to the indenter, and the indenter applies a static load to the steel mesh until the steel mesh is destroyed.

In some embodiments, the supporting composite structure of steel mesh+bolt+shotcrete is taken as an example. The main structural parts of the invention required for the test are servo hydraulic jack 931 and other loading assembly and mold groups. Before the test, the mold group is first fixed with a special anchor frame, and then the concrete is poured into the inner mold 510 and the outer mold 520, and the required test anchor is inserted into the inner mold 510 and the outer mold 520. The anchor may be inserted into the hole left by the retaining pipe 543. After curing to the required strength, the mold is lifted by the electric hoist 202, lifted to the appropriate position of the load transfer slide rail 109, and installed.

Furthermore, if the outer mold 520 is located on both sides of the inner mold 510, and the number of each group is 4, the number of the inner molds 510 is 3, then the required anchorage spacing is adjusted, and the mold is fixed with clamp plate 313, and then the steel mesh that needs to be tested is anchored to the bottom of the mold group through the bolt in the mold, and the concrete is sprayed at the bottom of the steel mesh to form a “4-3-4” anchorage test scheme. Similarly, the “3-2-3” anchorage test scheme can also be formed.

Furthermore, a pressure sensor can also be disposed at the nut of the anchoring steel mesh and the mold to obtain the required pre-tightening force of the bolt.

On the basis of the above implementation, furthermore, a displacement sensor may be disposed between the shotcrete and the steel mesh, and the deformation state of the steel mesh may be obtained in real time through the monitoring mechanism. In addition, acoustic emission monitoring sensors and optical fibers may be embedded inside and outside the concrete surface to monitor information such as fracture, temperature and deformation inside the anchorage.

On the basis of the above implementation, furthermore, in order to comprehensively monitor the overall deformation of concrete and steel mesh, multiple laser displacement meters may be set around the steel mesh, communicate and connect the monitoring mechanism to comprehensively monitor the deformation morphology of the bottom of concrete or steel mesh.

In some embodiments, after the bearing beam 932 is slid into the appropriate loading position, the servo hydraulic jack 931 applies a static load to the steel mesh through the indenter until the support system 530 is destroyed, so as to scientifically and reasonably evaluate the energy absorption threshold of the support system 530. The above supporting combination structure may be a shotcrete-rock bolt-mesh support system, or a steel mesh+anchor, steel mesh+shotcrete or a single steel mesh.

In the description of the present invention, it should be understood that the terms “first” and “second” are used for descriptive purposes only and are not to be construed as indicating or implying relative importance, nor as implicitly specifying the quantity of the technical features referred to. Thus, features qualified by “first” or “second” may explicitly or implicitly include one or more of such features. In the present invention, the term “multiple” means two or more, unless otherwise specified. Unless otherwise clearly defined and limited in this invention, terms such as

“mounting”, “connecting”, “connection”, “fixing” and similar expressions shall be understood in a broad sense. Those skilled in the art may interpret the specific meanings of these terms in the context of specific situations. In the description provided in this specification, the term “embodiment” or similar expressions refer to at least one implementation or example of the invention described in connection with the specific features, structures, materials, or characteristics of that embodiment or example. In this specification, the illustrative use of such terms does not necessarily refer to the same embodiment or example. Furthermore, the specific features, structures, materials, or characteristics described may be combined in any suitable manner in one or more embodiments or examples. Additionally, without contradicting each other, those skilled in the art may integrate and combine different embodiments or examples described in this specification, as well as features from different embodiments or examples. Although embodiments of the invention have been shown and described above, it should be understood that these embodiments are illustrative and should not be interpreted as limiting the invention. Those of ordinary skill in the art may make changes, modifications, substitutions, and variations to the above embodiments within the scope of the invention.

What is claimed is:

1. A testing apparatus for mechanical properties of a shotcrete-rock bolt-mesh support system, the testing apparatus comprises a main frame (100), a lifting and transporting mechanism (200), a mechanical testing mechanism, a testing platform (500) and a monitoring mechanism (600);
wherein the lifting and transporting mechanism (200) is disposed on the main frame (100);
wherein the testing platform (500) comprises a mold group and a support system (530); the mold group is movablely disposed on the main frame (100), and the support system (530) is disposed on a bottom of the mold group;
wherein the mechanical testing mechanism corresponds to a setting of the support system (530), configured to perform a dynamic impact testing or a static loading testing on the support system (530);
wherein the monitoring mechanism (600) communicates with the testing platform (500).

2. The testing apparatus for mechanical properties of the shotcrete-rock bolt-mesh support system according to claim 1, wherein the main frame (100) comprises a pedestal (101), a frame column (103), a frame beam (106), a platform column (104) and multiple sets of load transfer slide rails (109);
the frame column (103) and the platform column (104) are disposed on the pedestal (101), the frame beam (106) is connected to the frame column (103), and the lifting and transporting mechanism (200) is disposed on the frame beam (106); and
the load transfer slide rail (109) is connected to the platform column (104); the mold group is slidingly disposed on the load transfer slide rail (109).

3. The testing apparatus for mechanical properties of the shotcrete-rock bolt-mesh support system according to claim 2, wherein the load transfer slide rail (109) comprises a first load transfer slide rail (1091) and a second load transfer slide rail (1092); the first load transfer slide rail (1091) and the second load transfer slide rail (1092) both comprise two parallel sub-load transfer slide rails, two sub-load transfer slide rails of the second load transfer slide rail (1092) are located on both sides of the first load transfer slide rail (1091);
wherein the mold group comprises an inner mold (510), an outer mold (520) and an test rock bolt; the inner mold (510) is disposed on the first load transfer slide rail, and the outer mold is disposed between the first load transfer slide rail (1091) and the second load transfer slide rail (1092);
the test rock bolt is disposed in the inner mold (510) and the outer mold (520) in a detachable manner.

4. The testing apparatus for mechanical properties of the shotcrete-rock bolt-mesh support system according to claim 3, wherein the inner mold (510) comprises an inner mold shell and a support beam (513); the inner mold shell is connected to the first load transfer slide rail (1091) through the support beam (513);
the outer mold (520) comprises an outer mold shell and an outer mold clamp plate (523); the outer mold (520) is disposed between the first load transfer slide rail (1091) and the second load transfer slide rail (1092) through the outer mold clamp plate (523).

5. The testing apparatus for mechanical properties of the shotcrete-rock bolt-mesh support system according to claim 4, wherein the inner mold shell and the outer mold shell are provided with hole tubes (543).

6. The testing apparatus for mechanical properties of the shotcrete-rock bolt-mesh support system according to claim 2,
wherein the mechanical testing mechanism is a dynamic impact testing mechanism (300), the dynamic impact testing mechanism (300) comprises an impact weight (310), a crane (320) and a guide frame (330);
the crane (320) may be connected to the lifting and transporting mechanism (200); the impact weight (310) is connected to the crane (320) in a detachable manner; the impact weight (310) is disposed on the guide frame (330) and may move along the guide frame (330), a bottom of the guide frame (330) corresponds to the support system (530).

7. The testing apparatus for mechanical properties of the shotcrete-rock bolt-mesh support system according to claim 6, wherein the guide frame (330) is connected to the frame beam (106);
the impact weight (310) comprises a weight frame (311), a weight (312), a locking wheel (313) and a protective cylinder (314);
the locking wheel (313) is connected to the weight frame (311), the weight (312) is disposed on the weight frame (311), and a bottom surface of the locking wheel (313) is connected to the weight (312), and the protective cylinder (314) is connected to the weight frame (311) and disposed on a periphery of the weight (312).

8. The testing apparatus for mechanical properties of the shotcrete-rock bolt-mesh support system according to claim 2, wherein the mechanical testing mechanism is a test loading mechanism (900), the test loading mechanism (900) comprises a servo hydraulic jack (931) and a longitudinal slide rail (934); the longitudinal slide rail (934) is mounted on the frame column (103), and the longitudinal slide rail (934) is provided with a longitudinal moving support (933); the servo hydraulic jack (931) is disposed on the longitudinal moving support (933) in a detachable manner through a bearing beam (932); a bottom of the servo hydraulic jack (931) corresponds to the support system (530), configured to load a force on the support system (530);
anchoring piers (923) are disposed at a bottom of the support system (530), and the anchoring piers (923) are disposed on a pier-anchor slideway (921).

9. A testing method for dynamic impact properties of the shotcrete-rock bolt-mesh support system, this method is based on the testing apparatus for the mechanical properties of the shotcrete-rock bolt-mesh support system according to claim 7, wherein the testing method comprises the following steps:
constructing the testing platform (500), setting the mold group according to test requirements, and pouring concrete into the mold group; after concrete curing, installing test rock bolt in the mold group; when the test rock bolt is mounted in the mold group, installing the mold group on the load transfer slide rail (109), so that the test rock bolt is connected to the support system (530);
the dynamic impact testing mechanism (300) determines an impact area of the dynamic impact test according to a position of the testing platform (500), the guide frame (330) corresponds to the impact area, the guide frame (330) is connected to the frame beam (106), and the crane (320) is connected to the lifting and transporting mechanism (200), according to test requirements, setting the impact weight (310) of a corresponding mass and connecting it to the crane (320);
in the dynamic impact properties test, lifting the impact weight (310) by the lifting and transporting mechanism (200) to a position of the guide frame (330), the impact weight (310) coincides with a central axis of the guide frame (330), the crane (320) releases the impact weight (310), potential energy generated by a free fall of the impact weight (310) acts on the support system (530) on the testing platform (500), recording test data by the monitoring mechanism (600) and completing the impact test.

10. A testing method for static mechanical properties of the shotcrete-rock bolt-mesh support system, this method is based on the testing apparatus for the mechanical properties of the shotcrete-rock bolt-mesh support system according to claim 8, wherein the testing method comprises the following steps:
constructing the testing platform (500), setting the mold group according to the test requirements, and pouring the concrete into the mold group; after concrete curing, test rock bolt is mounted in the mold group; when the test rock bolt is mounted in the mold group, installing the mold group on the load transfer slide rail (109), so that the test rock bolt is connected to the support system (530); meanwhile, the support system (530) is connected to the anchoring pier (923);
according to a position of the testing platform (500), determining the impact area of the dynamic impact test, and then installing the bearing beam (932) with servo hydraulic jack (331) on the longitudinal moving support (933); and aligning a bottom of the servo hydraulic jack (931) to the support system (530);
static mechanical properties test, pressing the bottom of the servo hydraulic jack (931) against the support system (530), recording the test data by the monitoring mechanism (600), and completing the static mechanical properties test.
